(19) United States
(12) Patent Application Publication
(10) Pub. No.: US 2024/0027400 A1
(43) Pub. Date: Jan. 25, 2024

(54) SYSTEM AND METHOD FOR ASSESSING DETERIORATION OF A METALLURGICAL RUNNER USING ACOUSTIC EMISSIONS

(71) Applicant: HATCH LTD., Mississauga (CA)

(72) Inventors: Wai Lai Winnie Ying, Oakville (CA); Maria Tibbo, Toronto (CA)

(21) Appl. No.: 18/254,214

(22) PCT Filed: Jan. 18, 2021
(86) PCT No.: PCT/CA2021/050050

§ 371 Date: May 24, 2023

Related U.S. Application Data
(60) Provisional application No. 63/117,887, filed on Nov. 24, 2020.

(51) Int. Cl. G01N 29/04; G01N 29/07

(52) U.S. Cl. CPC G01N 29/043; G01N 29/07; G01N 2291/0289

(57) ABSTRACT

A system and method for assessing deterioration of a metallurgical runner using acoustic emissions. The system may be referred to as an acoustic emission runner integrity system (AERIS). The system comprises acoustic emission sensors mounted on the runner. At least some of the sensors can detect acoustic emission signals in the runner. The sensors may be able to emit acoustic emission signals into the runner. The sensors are in communication with a controller. The controller is configured to one or more of identify and monitor deterioration of the runner based on the acoustic emission signals of the sensors. The method comprises affixing AE sensors to the runner, detecting AE signals with the sensors, and assessing deterioration of the runner based on the AE signals of the sensors.

### FIELD

This specification relates to molten metal runners for molten metal and metallurgical furnaces.

### BACKGROUND

A typical metallurgical furnace is a container. Molten metal collects within the furnace container during its operation. The molten metal within a metallurgical furnace eventually needs to be transported out of the furnace to other locations within the furnace environment for further processing. A molten metal runner (also referred to herein as a runner) may be used for this step. The runner defines a molten metal path or cavity that is inclined such that the molten metal flows out of the furnace down the runner path under the force of gravity.

A molten metal runner has a base comprising a refractory lining and an outer steel shell. The molten metal path is within the refractory lining. The outer shell surrounds the bottom of the refractory lining. The top of a runner is typically not covered (or not completely covered) such that the molten metal in the runner is exposed to the atmosphere. The runner directs the flow path of molten metal from the tapholes in the furnace shell to another transportation vessel, such as a torpedo. The refractory lining within the runner helps protect the surrounding structure components of the runners from degradation due to thermal cycles experienced by the runner.

Molten metal runners, including troughs and landers for example, are still susceptible to wear and degradation, particularly wear and cracks within the refractory lining. This can lead to metal runouts/leaks if not remedied in time. During operation of the runners, the protective refractory lining deteriorates over time due to the mechanical and thermal stress, in addition to chemical degradation, from the molten metal as it traverses the lining. This results in a loss of overall refractory lining thickness and can also lead to the formation of cracks in the refractory lining. As the refractory lining deteriorates molten materials and aggressive chemicals penetrate into widening spaces in and/or between refractory bricks leading to further damage. These damages can include delamination (i.e. separation) of the layers in the refractory lining. Such delamination can exert stresses on the components of the runners, and may cause local deformation of the runner exterior. Deterioration of the refractory lining can also lead to structural failures that may cause the molten materials to runout from the runner.

If molten materials reach the exterior of the runner (metal shell), there is an imminent risk of severe injury to personnel working near the runner because the exterior shell of the runner is typically not capable of reliably retaining the molten material. Loss of heat transferability and conductivity are also known to occur as a result of the deterioration of the refractory lining, both of which may contribute to deformation and failure of the runner.

It is desirable to assess the structural integrity of runners to help determine what repairs may be required, and when to make such repairs. Making a reliable and accurate assessment of the condition of the runner, however, is difficult. Conventional methods for assessing the structural integrity of refractory lining in metal runners include manual visual inspection, laser measurements, or thermal analysis based on thermocouples readings.

Periodic shutdowns is required for visual inspection and laser measurements of the interior of the runners to review the thickness of the remaining runner refractory. This periodic shutdown however is costly, time consuming, and often inaccurate because only the outermost surface of the refectory lining can be inspected. A visual inspection may not be sufficient to identify all issues with a runner. Some of the issues may not be visible to the human eye. The hostile working environment of the furnace also makes it difficult to obtain accurate measurements of the runner. For example, extremely high temperatures in the furnaces, vibrations, ambient noise, dust, and electrical and mechanical hazards are known to distort measurements taken using conventional inspection methods.

Conventional deformation monitoring tools, such as strain gauges, can only measure deformation in the vicinity of the runner location on which they are installed. Further, strain gauges are unable to differentiate between elastic and plastic deformation of the runner. Therefore, elastic deformations detected by a strain gauge may trigger unnecessary maintenance or repair. Missing the optimal relining period of the runners is undesirable. If the re-lining is performed too late, it can result in molten metal runout from the runner, damaging properties and expensive unscheduled maintenance and repair. Relining the runners too soon, however, adds unnecessary expense and also results in loss of production due to the unnecessarily frequent shutdown of the runner for these repairs.

To use thermocouples to assess the integrity of a runner, the thermocouples are affixed to the sides of the metal runners and heat readings from those thermocouples are received by a computer when molten metal is flowing down the runner. A thermal analysis of the readings is performed by the computer to estimate the refractory wear in the runner trench. For example, differences in simultaneous heat readings between adjacent thermocouples can indicate that the area of the runner adjacent to the thermocouple that has the higher temperature reading, has deteriorated. Conventional thermal analysis using thermocouple data to determine runner refractory lining wear is, however, unreliable. This is because, in part, the analysis is negatively affected by the build up of material on the runner refractory lining over time and the limitation of the thermocouple coverage.

Build-up acts as an insulator causing lower temperature thermocouple readings, but the underlying refractory lining may be deteriorated and liable to unexpectedly break. For example, any wear or cracks in the underlying refractory due to thermal, chemical or mechanical stresses, would go largely undetected as the thermocouples register a lower temperature due to the insulating effects of the buildup. This allows the underlying wear or cracks to grow unnoticed. Build-up in the refractory is periodically removed however, thereby removing the insulating layer and subjecting the worn underlying refractory to direct contact with the molten material. The worn refractory may not be able to withstand direct contact with the molten material causing large breaks and runouts before any thermocouple readings can be used to warn of the failure. Also, the further the distance from a thermocouple, the lower the quality of information about that point on the runner. The assessment of those areas of the runner that are some distance from the thermocouple is mainly extrapolated from the areas that have better thermocouple coverage. This affects the precision of thermal analysis predictions. Furthermore, thermal analysis cannot be used to detect cracks and metal penetration that can cause severe damage to the refractory.

More generally, channels used as pathways for molten metal, acid, oil sand, and other hot and/or abrasive materials are vulnerable to structural deterioration similar to molten metal runners for metallurgical furnaces

A reliable system or method for accurately assessing runners without shutdown of the metallurgical furnace is desired. Furthermore, a system and method for accurately assessing the structural integrity of other channels which are similar to runners in environments similar to metallurgical furnaces, is desired.

### BRIEF DESCRIPTION OF THE FIGURES

FIG. 1 shows side, top and cross-sectional views of a metal runner equipped with a monitoring system according to an embodiment of the invention.

FIG. 2 shows a representation of a runner experiencing an acoustic emission event, and the detection thereof, by six sensors and the corresponding recorded waveforms, according to an embodiment of the invention.

FIGS. 3A-B shows a cross section of a runner with an acoustic emission monitoring system, and a representation of an acoustic emission event in a runner, according to an embodiment of the invention.

FIG. 4 is a block flow diagram showing the steps of monitoring acoustic emissions in a runner according to an embodiment of the invention.

FIGS. 5A-C shows three dimensional representations of a runner and the outputs from an acoustic emission monitoring system according to an embodiment of the invention.

FIG. 6 shows a velocity survey of a runner refractory lining according to an embodiment of the invention.

FIG. 7 shows a cross section of a runner equipped with an acoustic emission monitoring system according to an embodiment of the invention.

FIG. 8 shows a graph of refractory wear versus the number of acoustic emission events recorded in a runner.

FIG. 9 shows side, top and cross-sectional views of a runner equipped with an acoustic emission monitoring system according to an embodiment of the invention.

### DETAILED DESCRIPTION

The invention of the present disclosure is for a system and method for assessing the integrity or deterioration of runners, such as molten metal runners, using acoustic emissions. Runners comprise refractory that forms a channel for moving molten materials. The channel may also be referred to as a trough. The molten materials can be both hot and abrasive and cause wear along the channel surface and within the layers of refractory. As a result of use over time, stress events in the runner can result in deterioration of the refractory lining of the runner. These stress events include, for example, mechanically, chemically or thermally induced stress event. Stress events can generate acoustic emissions in the runner. The acoustic emissions can propagate through the refractory lining but are attenuated by free space/air or moving molten materials in the channel. In an embodiment of the invention, the acoustic emissions caused by stress events in the runner can be detected by acoustic emission (AE) sensors in the runner. The AE sensors may be arranged in a particular configuration in or on the runner walls.

Acoustic emissions in the runner may also be generated by the AE sensors. In an embodiment of the invention, AE sensors are affixed to the runner and emit and detect acoustic emissions in the runner. A controller in communication with the sensors receives signals from the sensors corresponding to the detected acoustic emissions. The controller identifies a deterioration in the runner based on the acoustic emissions of the sensors.

In a method according to an embodiment of the invention, a source sensor emits an acoustic emission into the refractory lining, and a detecting sensor detects the acoustic emission. In another embodiment, a source sensor affixed to the runner wall emits an acoustic wave and a reflection of the wave is detected by the same source sensor or another nearby sensor on the same runner wall. The methods can be repeated over a period of time for a portion of the runner to assess the integrity of the refractory in that portion of the runner by identifying a change in the travel time of the acoustic emission. In an embodiment, an increase in time from emission to detection of an AE signal over a period of time is determined to be a deterioration in the runner.

In another embodiment, a controller in communication with the AE sensors identifies the source location or type of acoustic emission. The controller can identify whether the acoustic emission originates from an AE event or an AE sensor. The controller may also identify the cause of deterioration in the lining. For example, some causes of deterioration include the initiation, growth or propagation of cracks in the refractory or the gradual wear of the channel molten material-refractory interface. When an AE event is detected by at least four sensors, the controller can locate the AE event within the refractory lining. In another embodiment, even if an AE event cannot be located, a damage zone in a segment of the runner lining can be identified using the number and magnitude of the acoustic emissions detected in that segment of the runner. By monitoring the integrity of the refractory in the runner over time, and identifying failures as they occur or when they are still relatively small, the system according to an embodiment of the invention can help avoid runouts and other complete system failures. Optimal runner refractory re-lining times can also be deduced from the rate of wear and magnitude of deterioration in the runner, thereby helping avoid pre-mature or late re-linings.

In an embodiment of this disclosure, a method for assessing the structural integrity of the a furnace runner is provided. The method comprises affixing sensors on the outer walls of a runner and performing a sequence comprising emitting an acoustic emission (AE) signal from a first sensor into a runner segment, detecting the AE signal at the first sensor or at a second sensor separated from the first sensor by a runner segment and recording a time from signal emission to signal detection. Then repeating the sequence over a period of time and identifying a deterioration in the runner segment based on a change in the recorded times over the period of time. An increase in the recorded times over the period of time may identify a deterioration in the portion of the runner. The velocity of each signal over the period of time may be determined based on a distance between the emitting and detecting sensors and the recorded time. A decrease in the velocity over time may identify a deterioration in the portion of the runner where the emitting sensor is not the same as the detecting sensor. The

AE signal may be received at the first sensor after reflection off a molten metal-refractory interface inside the runner. The deterioration below a channel of the runner may be identified based on an AE signal propagating between the first sensor on a first outer wall and the second sensor on an opposite second outer wall of the runner. The method may further comprise affixing the sensors on or embedded in a metal shell encasing the outer walls of the runner and/or affixing a higher density of the sensors around expected damage areas of the runner. The expected damage areas may be determined by any one of historical data, proximity to the furnace and preliminary testing of the runner. The method may further comprise detecting a second AE signal originating in the runner from a failure event, and determining a location and magnitude of the failure.

In an embodiment of this disclosure, an acoustic emission monitoring system for assessing the structural integrity of a furnace runner is provided. The system comprises a controller configured to identify a deterioration in the runner and its location based on acoustic emission (AE) signals originating from AE sensors and AE events, and a plurality of AE sensors mounted to outer walls of the runner and configured to detect and emit AE signals, the AE sensors being in communication with the controller to provide electric signals corresponding to one or more acoustic emissions propagating through the runner being detected by the sensors. The system may comprise at least four sensors. The controller may locate the AE event based on the electric signals from at least four sensors. The controller may be configured to identify the deterioration in the runner and its location based on the AE signals detected by the sensors over a period of time and may be further configured to determine a magnitude of the AE event. The controller may also determine a damage zone in the runner based on the magnitude of the AE event exceeding a threshold and/or based on a number of AE events occurring in the portion of the runner. The controller may further be configured to identify the type of failure based on a moment tensor inversion analysis. The sensors may be configured to continuously or periodically receive and emit the acoustic emissions propagating through the runner. The sensors may be detachably or permanently mounted on the outer walls of the runner and a higher density of the sensors may be mounted around expected damage areas of the runner. For example, a higher density of the sensors are mounted to the runner portion closest to a furnace taphole. At least a portion of the plurality of sensors of the system are mounted to the runner walls at a height that is below a channel in the runner.

In another embodiment of this disclosure, a method for assessing the structural integrity of a furnace runner, the runner comprising a trough for flowing molten metal, a first sidewall, and a second sidewall opposite to the first sidewall, is provided. The method comprises affixing a plurality of sensors on the first and second sidewalls of the runner, the plurality of sensors arranged with at least a first of the sensors affixed at a first height on one of the sidewalls to detect an acoustic emissions (AE) signal passing through the runner below the trough, and a second of the sensors affixed at a second height on the other sidewall to emit or detect the AE signal passing through the runner below the trough that reaches the first sensor. The method further comprises sensing AE signals in the runner over a period of time using the sensors, filtering the signals based on a pre-determined frequency range, and determining the structural integrity in a portion of the runner below the trough based on AE signals associated with the first and second sensors. At least one of the first height and the second height may be below the trough and/or the first height and the second height may be the same. The structural integrity in a portion of the runner may be determined by identifying a damage zone or locations of AE events in the runner based on the AE signals associated with the first and second sensor over the period of time. The first and second sensors may continuously detect AE signals produced by AE events occurring in the runner. The second sensor may periodically emits an AE signal below the trough while the first sensor detects the emitted AE signal.

In another embodiment of this disclosure, a system for monitoring acoustic emission events is provided. The system comprises a molten metal runner, the molten metal runner comprising a first sidewall and a second sidewall opposite to the first sidewall, and a trough for flowing molten metal, and at least four acoustic emission (AE) sensors mounted on sidewalls of the runner. A first of the sensors is mounted on one of the sidewalls at a first height to detect an AE signal passing through the runner below the trough, and a second of the sensors is mounted on the other of the sidewalls at a second height to emit or detect the AE signal passing through the runner below the trough that reaches the first sensor. The system further comprises a controller configured to determine the structural integrity in a portion of the refractory lining below the trough based on the AE signal associated with the first and second sensors. At least one of the first height and the second height may be below the trough and/or the first height and the second height may be the same. The controller may be configured to identify a damage zone or locate AE events in the runner based on the AE signals associated with the first and second sensor. The first and second sensors may be configured to detect AE signals produced by AE events in the refractory lining. The second sensor may be configured to periodically emit an AE signal while the first sensor is configured to detect the emitted AE signal.

In industrial processes, molten metal runners facilitate a pathway for the molten metal to flow from a furnace where it is produced to a transport vehicle where it can be transferred for further processing. Blast furnaces for example comprise tanks that are continuously supplied with fuel, ore and/or limestone materials from a top section of the furnace and hot air from a lower section of the furnace. The mixing of hot air with the falling material causes heated chemical reactions to produce molten metal and slag. The furnace is then tapped in a lower section to release the molten metal and slag onto runners. In some cases the furnace is tapped through one taphole and in other cases through multiple, alternating tapholes, depending on the size of the furnace. Tapholes are clay filled notches in the lower section of the furnace, located below the tuyeres that introduce hot air into the furnace. Tapping can be performed by drilling open the clay notch, or by other known means, to release the molten metal settling on the bottom of the furnace. In some furnaces, multiple tapholes are positioned at specific positions to release only molten metal or only slag as desired, while in other furnaces, a single taphole can be used to release both molten metal and slag. When a slag and metal mixture is released from the tapholes, the runner may also have a skimmer that only permits the denser molten metal to pass and continue to the transport vehicle, while the less dense floating slag is collected behind the skimmer. The collected slag may be re-directed to an adjacent runner for transport to slag pits. Once the tapping cycle is complete and the metal is released, the taphole or holes are re-sealed. Typically, a tapping cycle end is signaled by the release of gas from the taphole. With a single taphole, the tapping cycle may be repeated every 30 to 90 minutes. With multiple tapholes, it is possible to always have at least one taphole open to offer continuous flow of molten metal to the runners by alternating the open taphole location.

The runners are typically constructed with a negatively sloped floor or molten metal path. This facilitate the movement of the molten metal along the runner using the force of gravity from the higher position closest to the furnace, to the lower position closest to the end of the runner. The runner may connect to a transport vehicle. The transport vehicles, for example torpedo cars, collect the molten metal from the runner and transfer the metal to steelmaking or other processing facilities.

Runners used to transport the molten materials comprise a refractory lining that interfaces with, and can withstand the heat of, the molten metal. This refractory lining forms a pathway for the molten metal. The refractory lining is encased by a metal shell. The metal shell and refractory combination protects the surrounding environment from the heat of the molten material and provides a structurally sound pathway for transporting the molten material. Because of the weight of the refractory forming the runner path and the additional weight of the molten material flowing through the runner, runners are typically constructed such that their base or bottom is supported on the floor. In some cases however, the runner may be elevated from the floor. A molten metal runner in a metallurgical furnace environment may for example be constructed directly on the floor starting adjacent to the furnace and extending a distance to the location of the transport vehicle outlet.

The runner may comprise an inner working refractory layer that is in direct contact with the molten metal. This inner working refractory layer is generally thicker than other portions of the runner and sustains the most wear due to its direct contact with the hot and abrasive materials. The working layer forms the open top trough which forms a path or channel for the molten material to flow. The working layer typically sits atop a safety layer (comprising additional refractory) for further protection. The two refractory layers may be made from the same refractory material or different refractory material depending on runner design. The two layers are typically within a protective metal shell. The metal shell typically rests on the floor or ground of the metal processing facility. Between the shell and the safety layer, there may also exist a castable layer. The castable layer acts as a type of glue or paste that adheres the shell to the safety refractory and acts as a further extension of refractory material before the covering metal shell.

When the furnace is tapped, molten metal at furnace temperatures contacts a much cooler runner immediately outside the taphole. As the metal is pushed along the sloped runner path by forces of gravity, the metal slightly cools such that the highest temperature of the molten metal contacts the runner portion closest to the taphole and the lowest temperature of the molten metal contacts the runner portion closest to the transport truck. Tapping cycles further result in the working refractory layer cycling between hot and cold surface conditions. Thermal stresses may be caused by this hot and cold cycling. Thermal stresses may additionally result from differences in thermal expansions within various parts of the runner body. For example, thermal stresses may arise when the working refractory layer and the safety refractory layer are made from different refractory material having different thermal expansion coefficient. In another example, the working refractory and the safety refractory may be the same material, but the refractory material may be comprised of various components with different thermal expansion/contraction behaviours. In an example, where the hot molten metal from the furnace contacts the working face of the refractory layer, the surface refractory in contact with the metal will try to expand while the lower layers will resist this expansion causing compressive stress near the surface and tensile strength within the interior of the refractory body. Similarly, when the taphole is closed and the runner cools due to the surrounding atmospheric temperatures, the surface may undergo contraction that is resisted by the interior material. In this case, tensile stress may occur at or near the surface while compressive stress may occur within the interior. These thermal stresses may lead to cracks, fractures and other failures on or near the surface of the refractory working layer or deeper within the interior of the refractory layers, for example beneath the molten metal channel.

Mechanical stresses may also contribute to runner refractory deterioration. In some cases, build-up of cooled materials in the runner will require manual extraction. Manual extraction of build-up has been known to fracture or weaken the surface of the working refractory layer. Similarly, the abrasive force of the molten metal travelling along the runner may wear the refractory working face over time. Because of the consistent pattern of molten metal flow along the runner, the working refractory surface experiences increased wear in some areas, for example those in constant contact with the flowing molten metal, as compared to other areas.

The refractory material used for the metal runner is chosen to be chemically inert to the molten metal for which it is intended to move. However, in some cases, failures in the refractory lining may also occur due to chemical reactions between the molten metal and the refractory. In other cases, deterioration of the refractory surface may cause refractory material to mix with the molten metal, and may change the finished metal product composition. Similar to thermal and mechanical stresses, chemical reactions between the molten metal and the refractory surface may cause fractures, or spalling, of the refractory. In some cases, the chemical reaction may also cause corrosion or degradation of the refractory working surface. Two or more of chemically, thermally or mechanically induced stresses may be experienced simultaneously.

Refractory failure may be a result of gradual wear of the working face or due to cracks propagating through the refractory material. Cracks are particularly detrimental to the runner operation. Cracks may cause entire sections of the refractory to break off, or may allow molten metal to infiltrate through the refractory lining towards the metal shell. Although any crack may be cause for concern, cracks occurring parallel to the working face tend to cause more damage as they result in larger loss of refractory as compared to cracks occurring perpendicular or normal to the working face. Loss of refractory or infiltration of molten metal towards the metal shell increases the chance of total failure of the runner and places working personnel in danger of molten metal runouts. Monitoring and detecting these runner failures is important in order to rectify any problems in the refractory before the occurrence of any metal runouts or complete failure of the runner.

Events causing failure in the refractory lining such as crack initiation, propagation or growth produce acoustic emission (AE) signals that can be detected by AE sensors. Acoustic emission signals refer to spherical acousto-elastic waves which may, for example, be generated by the rapid release of energy caused by an event in the refractory lining. An event may be any of a thermal, chemical or mechanical stress event in the runner refractory that causes a failure or compromises the integrity of the refractory lining. AE signals may also be emitted directly from an AE sensor and detected at the same or a different sensor in order to determine the wear or wear-rate of the refractory.

In an embodiment, AE sensors are used to detect acoustic waves propagating through the refractory. The sensors may be calibrated to ignore or filter out background environmental noise. For example, when an acoustic wave front signal received by an AE sensor exceeds a predefined rise time criteria and amplitude threshold, for example as defined by typical background noise, the AE “event” or “hit” is detected/recorded. When several AE sensors receive an AE hit within a defined time window, an AE source or AE event can be located. When several AE events with increased amplitudes are detected by sensors covering a section of the runner, that section of the runner may be determined to be a damage zone.

The acoustic emission sensors are selected such as to include sensors configured to detect and emit frequencies in the 10 kHz to 1 MHz range. The specific sensors for a particular runner or lining can be chosen such as to optimize sensing for that runner. For example, sensors are chosen to optimize information collection considering that higher frequencies attenuate more than lower frequencies, but also that, higher frequencies carry more information than lower frequencies. Each sensor can both send and receive signals through the refractory material. All the AE sensors may be identical. Alternatively, the plurality of AE sensors may include more than one type of AE sensor. The AE sensors detect and convert acoustic emissions generated and/or propagating within the runner lining into corresponding electrical signals for manipulation to determine the integrity of the refractory lining. The AE sensors may be detachable from the runner using a suitable detachable connecter. For example, a magnetic sensor holder for attachment to the metal shell may be used to detachably secure the sensors to the surface of the metal shell. Alternatively, some or all the AE sensors may be permanently mounted to the runner.

In an embodiment, the method comprises positioning an array of AE sensors on or in the side walls of the runner. Where a runner is supported above the ground by other support means, the AE sensors may also be positioned on the bottom of the runner. The AE sensors are configured to detect acoustic emissions within the runner over a period of time. Readings from the AE sensors can then be used to identify wear or failures in the refractory. The acoustic emissions detected may be used for example to identify the number and amplitude of AE events in the runner, identify the events corresponding to a formation, growth or propagation of cracks in the runner refractory lining and/or to monitor the wear of the lining. The method may also be used to determine locations of where the events occurred in the runner that resulted in the acoustic emissions and, determine damage zones based on locations and/or magnitudes of the AE events. The detected acoustic emissions may also be used to correlate the AE events and their intensities with the amount of wear in the lining, and create velocity tomography to determine the lining deterioration.

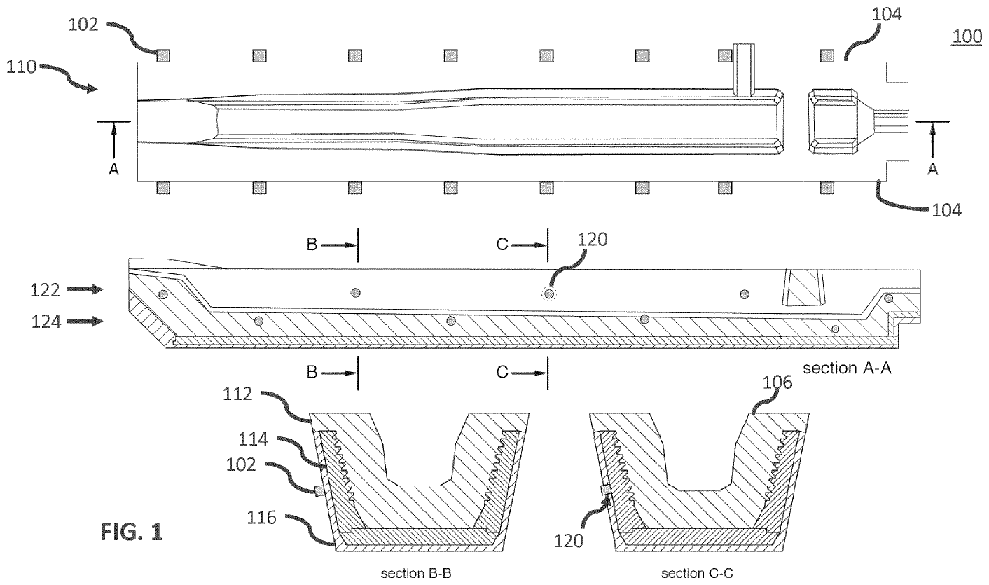

FIG. 1 shows an example of an acoustic emission runner integrity monitoring system 100. The system 100 comprises a plurality of acoustic emission sensors 102 arranged along sidewalls 104 of a molten metal runner 110 in accordance with an embodiment of this invention. The metal runner 110 may comprise at least two layers of refractory including the working refractory layer 112 and the safety refractory layer 114 which may be made of the same or different refractory material. The sensors 102 may be arranged on the surface of the metal shell 116 of the runner. The sensors 102 may be arranged in an array. The cross-section along line A-A shows the sloped runner path where the molten metal travels. In addition, the cross-section along line A-A is overlaid with sensors to show an example sensor arrangement from a side-view. For clarity, these sensors are placed on or in the outer wall of the runner and not along line A-A. The cross-section along lines B-B and C-C show for example the arrangement of a sensor on or embedded in the outer wall of the runner.

Cross-section B-B of FIG. 1 shows a sensor 102 placed on the metal shell 116. In some cases, there may be a gap between the metal shell and the safety refractory layer 114, for example if little or no castable is used. In such cases, as shown in cross-section C-C of FIG. 1, small holes 120, big enough to fit the sensors, can be made in the metal shell. A sensor may be inserted into each hole such that it is in direct contact with the refractory. Air gaps between the contact point of the sensor and the refractory being monitored will cause the acoustic emission signals to attenuate in the gap before reaching the sensor for detection. This sensor placement minimizes or eliminates the signal attenuation that could be caused by the gap between the shell and the refractory.

In the example as shown in FIG. 1, the sensors 102 are evenly spaced on both sides of the runner 110, on or embedded in, the metal shell 116. The sensors may all be placed on the outside of the metal shell, all embedded in the metal shell so as to directly contact the refractory layer or arranged in some combination of the two, in order to optimize the signal collection at the sensors. The path for flowing metal in the runner is a trough with an open top and a bottom on which the molten metal flows. The refractory lining defines the trough by forming the bottom and sides of the trough. The sensors in FIG. 1 are arranged in two rows: a top row 122 and a bottom row 124. The top row of sensors lie between the top and bottom of the trough. The sensors in the bottom row lie below the trough. This arrangement of sensors may help increase the detection coverage of the acoustic emissions in the runner and address issues which are unique to runners.

Because molten metal is repeatedly flowed down the trough in cycles, the bottom of the trough may be more susceptible to experiencing structural integrity issues, or certain types of structural integrity issues, as compared to other parts of the trough or other molten metal containing vesicles in a metallurgical furnace environment. For example, the weight of the molten metal exerted on the trough will be greatest at the bottom of the trough (where it is deepest) than the sides of the trough. Also, since the molten metal always flows in the same direction in the trough (i.e. top to bottom), the bottom of the trough may experience greater abrasion. Furthermore, the bottom of the trough may experience greater and more sustained fluctuations or differences in heat each time molten metal is initially released from a furnace tap and allowed to flow down the trough. An arrangement of sensors on or in sidewalls that are on opposite sides of the trough may enable detection of acoustic emission signals occurring or passing below the trough. Detection, at both sidewalls, of the same signal occurring or passing below the trough can help better identify structural integrity issues below the trough and/or at the bottom of the trough. Sensors positioned at a height that is below the trough can detect acoustic emissions across the runner, from one sidewall to an opposite sidewall. For example, a select AE signal emitted from an AE event occurring within the runner below the trough may be detected by sensors located on opposite sidewalls of the runner. In this way, the AE signal has passed below the trough. In another example, an AE signal may be emitted from an AE sensor on one of the sidewalls so as to reach and be detected by an AE sensor on an opposite sidewall. For this AE signal to have reached both sidewalls, it must have necessarily passed below the trough.

In an embodiment, a first sensor is located on a sidewall and a second sensor is located on an opposite sidewall. At least one of the first and second sensors is positioned at a level that is below the trough for the first and second sensors to cooperatively detect the same signal passing below the trough. The first and second sensors may both be posited at a level that is below the trough.

The sensors may be mounted or affixed to the runner sidewalls in any linear, curved, zigzag or other arrangement, so long as the location of each sensor is known. Each sensor is separated from at least one other sensor by a segment of the runner refractory. In some cases the sensors are separated by a segment of the runner along the same side wall. For example, the sensors may be separated from one another by a vertical, diagonal or horizontal distance. In other cases, the sensors are separated by a segment of the runner extending from one sidewall to an opposite sidewall. The sensors may be placed in certain locations to minimize the parts of a runner for which an AE event could not be detected (also referred to herein as a blind spots). In an example, no two sensors are spaced more than a distance of 3 meters from one another such as to minimize the blind spots while also accounting for some redundancy in sensor coverage to increase detection accuracy. Sensors may be placed even closer to one another to further increase accuracy however this approach is more costly. In order to determine the maximum distance allowable between sensors before a signal attenuates beyond an acceptable level before reaching the sensor, testing/calibration of the specific refractory material being used may be conducted to determine the maximum distance waves can travel in the refractory before attenuating. More or less sensors may be used according to the size of the runner. More or less sensors may also be chosen according to the desired location accuracy output and having regard to any cost considerations. In order to locate an event occurring within the three dimensions of a physical runner, at least 4 sensors are required. Recordings from AE events detected by less than 4 sensors may be used for determining the intensity of AE activity and/or wear rate of the refractory in a specified location.

Sensors may also or alternatively be arranged on the bottom of the runner if the bottom of the runner is accessible. Typically, however, the bottom of the runner is not accessible because the base of the runner is in contact with the ground for the needed support due to weight. The runner and molten metal are very heavy. When the base of the runner is not accessible, the sensors may be placed on each side of the runner and arranged so that the span between sensors on opposite walls passes through the refractory that defines the bottom of the runner channel. In this way, the inaccessible base of the runner may be assessed for integrity.

In other cases, sensors may be placed on the working refractory layer extending on to the top surface 106 of the runner working refractory layer 112, which is not covered by the metal shell or safety refractory layer, and which is not in direct contact with the molten material. The sensors may be evenly spaced, spaced at random or clustered close together. A higher density of sensors can be placed around expected damage areas that are more susceptible to wear or crack events. For example, more sensors may be placed near tapholes where the molten material enters the runner as this is where the molten material will be at its hottest temperature, and likely to cause the most damage/wear to the refractory. However, preliminary testing of the runner using the sensors, as well as historical data on common damage areas, can also be used to determine areas expected to sustain more damage. These factors may be used to determine if more or less sensors should be placed in such areas.

Before the acoustic emission signals are detected and used to locate the source or amplitude of an event, or wear in the refractory, the sensors may be calibrated to account for environmental/background noise from various controlled sources. This can then be used as a baseline and filter. Any operations being carried out by or near the runner (maintenance, heat changes, tapping, drilling, etc.) can be accounted for in the calibration. By correlating specific background events to their unique acoustic signature, these signals can be filtered out. The remaining acoustic signals collected by the sensors will be the result of AE events occurring in the lining. In addition, threshold amplitude (intensity) limits and parameters such as the rate of amplitude increase due to refractory wear can be selected based on the calibration results. A baseline for the amplitude/magnitude/energy, of the signals is preferably established while molten metal is present along the runner. The amplitude of these signals can then be monitored over time. Detecting runner wear or a crack may comprise determining an increase in the amplitude of the signals over the time period being monitored. Any AE activity that exceeds the threshold amplitude limits and is within the frequency bandwidth is recorded by the sensor. Concurrently or as an alternative where only relatively low background noise is present, for example where only the flow of molten material contributes to the background noise, the sensors may be selected such that the lower end of their operating range is higher than the known lower frequency background events. This helps reduce the detection of the relatively low frequency, unwanted and/or interfering sound waves via the AE sensors.

In an embodiment of the invention an acoustic emission runner integrity monitoring system is provided for detecting acoustic emission events in the refractory lining of a runner. The acoustic emission signals emitted by events in the refractory are detected and recorded by the acoustic emission sensors. In an embodiment, the sensors may be monitoring for, receiving, and recording, acoustic emission signals over a period of time. The detected signals may then be used to create a three dimensional (3D) map of the AE events within the refractory. The 3D mapping may provide a location and magnitude of the crack event in order to determine potential leak regions in the lining/refractory. The locations that are determined may be within centimeters of the actual location of the event. The accuracy of the location measurement increases with an increase in the number of sensors detecting acoustic emissions caused by the same event.

The AE monitoring system may also be configured to assess the refractory wear over time in specified sections or segments of the runner. The location, number and magnitude data received by the sensors may be used to identify segments of the runner as damage zones. Even if an event is not specifically located by the sensors, the amplitude of waveforms received from a segment of the runner can be used to determine areas of high energy within the refractory. Areas of high energy indicate bigger or more events occurring in that area, and can be used to determine general damage zones in the refractory that may need to be further investigated. More AE events occurring in a segment of the runner may indicate an increase in deterioration of that segment of the runner.

The AE monitoring system may also be configured to identify the type and severity of the damage in the runner lining. In such a configuration, the AE events are treated as point sources and analyzed using a SiGMA procedure (simplified Green's function for moment tensor inversion analysis). The direction of crack propagation can be derived from the eigenvectors while the classification of the cracks as tensile or shear cracks, is performed by the eigenvalue analysis of the moment tensor, where X, Y and Z denote the shear ratio, the deviatoric tensile ratio, and the isotropic tensile ratio, respectively. According to the SiGMA procedure, the acoustic emission sources are classified based on the following criteria: X<40% classified as tensile cracks; 40%<X<60% classified as mixed mode cracks; X>60% classified as shear cracks. The moment tensor inversion calculation can determine for example whether an event was caused by shearing at the interface between the molten metal and the working refractory layer, by thermal cracking deeper within either the working or safety refractory layers, by compression stress, tensile stress, or even by stick-slip behavior, for example between the layers of refractory.

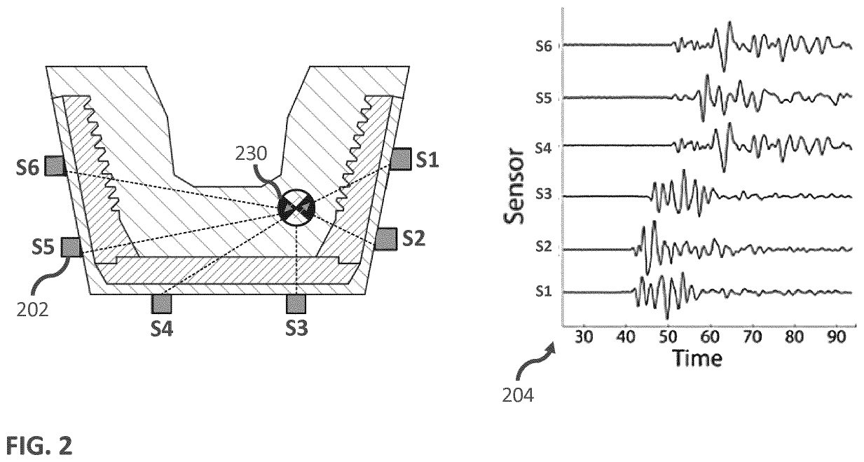

FIG. 2 is a schematic diagram depicting an AE event being detected by six surrounding sensors 202 and the corresponding AE sensor outputs 204 from that event in accordance with an embodiment of this invention. Each sensor 202 has a known X, Y and Z position while the acoustic event 230, which may be the start of a crack for example, occurs at an unknown X₀, Y₀, and Z₀ position. Once the event occurs, spherical acoustic waves are generated by the rapid release of energy caused by the event. The waves propagate through the materials of the runner to eventually reach the sensors to be detected. Each sensor detects the arrival time of the waveform. FIG. 2 shows only a single event 230 for clarity and discussion. Typically, however, a number of events may occur simultaneously in the same area and will be detected by the sensors configured and arranged to cover that area. In the single event example in FIG. 2, it can be seen that the event occurs closer in space and about equidistance from sensors S1 and S2. Sensors S1 and S2 therefore detect the arrival of the event waveform at approximately the same time, in this case, about 42 microseconds. Sensor S3 is a slightly further distance in space from the event location than sensors S1 and S2, and therefore records the detection of the waveform from the event at a time that is slightly after sensors S1 and S2, in this case at about 45 microseconds. Sensors S4, S5 and S6 are located significantly farther away in space from the location of the AE event as compared to sensors S1, S2 and S3 and therefore detect a waveform arrival time even more delayed than that detected at S3, in this case at around 50 microseconds. Since the acoustic wave generated by the event travelled a longer distance through the refractory material to reach sensors S4, S5 and S6, the signal detected at these sensors shows, expectedly, lower energy or wave amplitudes than the closer signals. This is because the refractory can contribute to some signal attenuation while the longer distance traveled by the signal to reach the sensor uses more of the signal energy. The known sensor locations and the waveform arrival times can be used to determine the three dimensional location X₀, Y₀, Z₀ of the event within the runner.

The AE sensors can also register whether the arrival waveform is an up trough or a down trough. The up and down troughs correspond to different movement of the refractory material. For example the black portions of the circle depicting an event 230 in FIG. 2 illustratively represent material that is being pushed or compressed at the event location so as to result in an up trough acoustic emission signal (see the black right quadrant and sensors S1 and S2 of graph 204, for example). The white portions of the circle representing an event in FIG. 2 illustrates that the material at the location of the AE event is under tension or being pulled apart so as to result in a downward trough acoustic emission signal. Sensors S1, S2, S4, S5 and S6 each receive a waveform from the black portion and therefore register an up trough (compression stress) while sensor S3 receives a waveform from the white portion and therefore registers a down trough (tensile stress). This information can be collected and used to determine the type of event that has occurred, for example using the previously described moment tensor inversion.

The waveform arrival times and time delays between sensor recordings as shown in FIG. 2, as well as the known locations of the sensors may be used to determine the location of an event. For an array of i sensors their coordinates are: (x1, y1, z1), (x2, y2, z2), . . . , (xi, yi, zi). Only the first breaks of the P-wave (primary wave) arrival times are used for the location of acoustic emission events. From the Pythagorean theorem, the i-th sensor located at xi, yi, zi will detect the signal when Equation 1 is satisfied (ti is the time required to reach the i-th sensor, c is the wave velocity).

(x′−i²)+(y′−i²)+(z′−i²)=ctᵢ² equation 1

For an array of i sensors, i unique non-linear equations can be formed. If t0 is the travel time required to reach the sensor closest to the source and Δti is the time difference between arriving to the closest sensor and arriving to the i-th sensor, then: ti=t0+Δti. The source location can be determined by solving for the four unknowns x′, y′, z′ and t0 using four or more measured Δti values. Large sensor arrays may be used to allow over-determination and enhanced accuracy.

AE events in a runner may comprise negative moment magnitudes and frequencies within the 10 kHz to 1 MHz range. In a 3D environment, at least four sensors, preferably five or more, receive the AE signal in order to locate the event. Four sensors may be used to detect a single major event. However, when monitoring the lining of a runner, several events may occur adjacent in both time and space, and therefore more sensors may be required to detect the events. Multiple sensors may help ensure enough wave fronts from the same event are detected by the sensors in order to accurately locate the events. When an event occurs that produces a stress wave that exceeds a threshold amplitude, for example an amplitude above the expected background noise threshold, the sensor closest to the event detects the arrival waveform first and other surrounding sensors attempt to collect information from the same event within a specified time frame or window related to the specific waveform. Only data associated with the right time frame of a triggered waveform is collected. If not enough of the surrounding sensors pick up information regarding the same event, then the time difference of the waveform arrival times will not be able to be determined, and the event will not be located. In circumstances where the event cannot be located, the AE sensors can still register the amplitudes of the waves. An increased amplitude of waves in a particular zone in the runner may indicate an increase in energy in that zone that is correlated with increased damaging events.

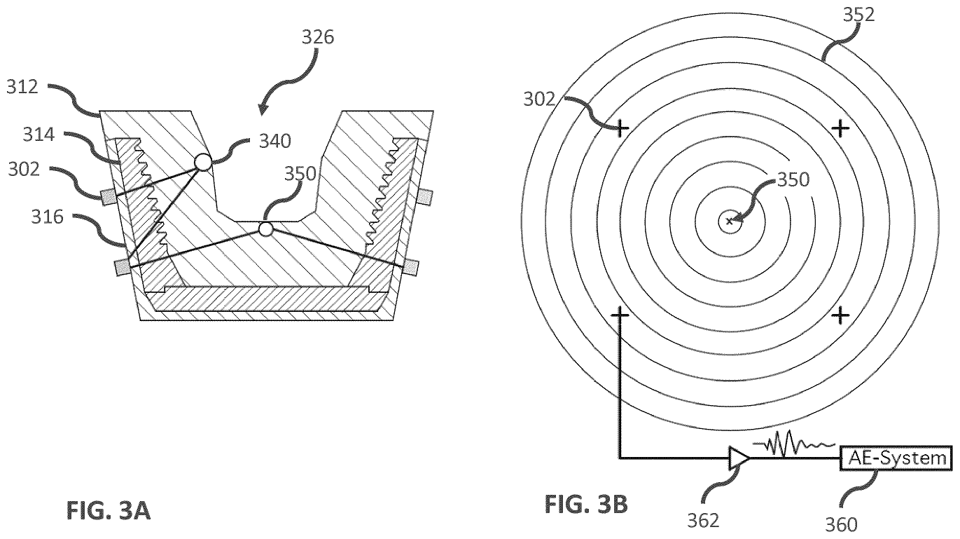

FIG. 3A shows another example in accordance with an embodiment of this invention of two events occurring in the refractory lining. The refractory lining as shown in FIG. 3A includes a working refractory layer 312, a safety refractory layer 314 and a metal shell 316. Any number of events may be occurring in the refractory layers however only two events are shown in FIG. 3A for clarity and discussion. Thermally induced cracking events may account for the most acoustic emission events in a runner. These events are expected to be found in the working refractory layer closest to the flow of hot material. Where the safety refractory material and the working refractory material are different materials with different thermal expansion co-efficient, movement between the bricks may cause additional acoustic events (cracking) around the interface between the two layers. In circumstances where the molten material builds up in the channel 326, removal of the build-up may also contribute to mechanical damage causing cracking at the refractory-molten material interface. Moment tensor inversion analysis may be used to determine the type of failure caused by the AE event. For example, the moment tensor inversion may determine that the failures or cracks in the runner were caused by friction movement between the refractory layers. Failures attributed to friction between refractory layers may be mitigated, for example, by replacing one or both refractory layers with materials having closer thermal expansion coefficients.

The events 340, 350 shown in FIG. 3A may be caused for example by thermal induced cracking or mechanical damage during cleaning of the runner. Event 340 in FIG. 3A has occurred on the side of the channel 326 where molten metal or other abrasive/hot material flows. In this case, only the sensors 302 on the same side of the runner will detect the P-wave arrival time and entire waveform signals from this event, as the seismic signals will not propagate through the molten metal or other material in the channel 326, or through dead space when no material is present in the channel. In order to get an accurate location in three dimensional (3D) space for these types of events, both P-wave arrival times and S-wave arrival times can be used in accordance with an embodiment of the invention. The P-wave is a compression seismic wave that arrives at the sensors first, as it is the fastest. The S-wave is a shear wave that is also generated from the AE event, it is a much slower wave that is polarized perpendicular to the P-wave. The S-wave arrival time is located further along the waveform received by the sensors. A computer which is configured to gather and analyze the sensor readings may also be configured to detect the P-wave and the S-wave arrival times from the waveform signals, and then determine the 3D location of the AE event. However, where the location of the event cannot be determined by the sensors, the sensors can still be used to identify the wave amplitudes received around a portion of the runner and can be used to identify areas of higher energy, signaling a damaged zone of the runner.

Event 350 in FIG. 3A has occurred beneath the channel 326. When AE events occur underneath the channel, the sensors on both sidewalls of the runner can receive the waveform signals. Using the waveform signals, a controller is used to identify the P-wave arrival times and uses this in combination with the knowledge of the wave velocities/arrival times to perform the location algorithm including for example collapsing grid search, Geiger routine, and simplex routine. In the example shown in FIG. 3A, event 350 is detected by two sensors and will not be located. The amplitude of the event may be recorded and used in combination with amplitudes of surrounding events to determine whether this portion or segment of the refractory is damaged. If event 350 is detected by at least four sensors, the location of the event within the runner can be determined.

In the example shown in FIG. 3A, both events 340, 350 are detected by AE sensors that act as receivers. These sensors may also be configured to emit acoustic signals. In the case of the embodiment in FIG. 3A however, the AE sensors passively and continuously, in real-time, listen for AE event signals (indicative of a stress in the refractory) produced by the events in the refractory and record those signals.

FIG. 3B shows, for example, event 350 emitting spherical acousto-elastic waves 352 that can be detected by each of the four surrounding sensors 302. In some cases, the signal may attenuate before reaching a sensor due to contacting the empty space or molten metal in the channel or traveling too far a distance in the refractory, which may limit the detection of the signal at some sensors. Each AE sensor may be linked to a corresponding AE preamplifier 362. The AE preamplifiers are configured to receive the corresponding electrical signals from the AE sensors and to transmit an amplified electrical signal to an AE system 360 comprising a controller. The preamplifier may alternatively be integrated into the sensor or the controller. The plurality of AE preamplifiers may be communicably linked to one or more controllers using a plurality of suitable data cables.

A controller may include any one or more of an input module, a filtration module, a processor, a memory module, an operator Input/Output (I/O) module and an output module. The input module can be any suitable module that can be configured to receive electric signals from the plurality of AE sensors/preamplifiers, and transfer the signals to another controller component. The input module can be a multi-channel input module and can include an analogue to digital converter and any other suitable components. The filtration module can include a combination of hardware and software components that can be configured to help filter signal noise and standard operating sounds from the AE signals detected by the AE sensors. The filtration module can include, for example, high pass, low pass and/or band pass filters and pattern recognition software components. The processor may be linked to a plurality of other controller components, and can be any suitable processor. The memory module is configured to store system reference values, such as AE threshold values, and can be queried by the processor. The memory module can also store a variety of other software modules, including operating systems and sensor interface software. The operator I/O module is configured to enable a system operator to engage the AE monitoring system, for example to modify the operating parameters of the AE monitoring system. The I/O module can include physical and graphical interface components, including, for example a keyboard, a mouse, a touchscreen and a display monitor. The output module is linked to the processor and is operable to generate and output a variety of output signals. The output signals can include a variety of signals, including, for example, warning signals, alarm signals, control signals, sensor control signals and feedback signals. The AE monitoring system can also include a display apparatus. The display apparatus can be operable to provide information to a system operator. The display apparatus can include visual transducers (including for example display screens, lights and gauges), audible transducers (including, for example, horns, bells and sirens) and any combination thereof. The display apparatus can display the waveforms detected from AE events. These waveforms can be further analyzed through a number of operation, including for example through fast Fourier transform algorithms to filter out unwanted frequencies, for example frequencies that lie outside the desired acoustic emission frequency range.

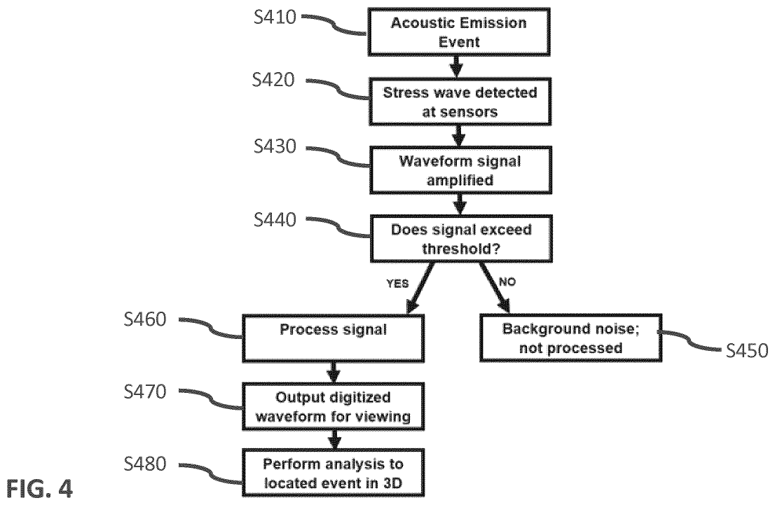

FIG. 4 is a block diagram of a process according to an embodiment of this invention. When an acoustic emission event occurs S410, for example due to thermal induced cracking in the refractory material, the AE event results in a spherical waveform that can be received or detected by surrounding sensors S420. The raw AE waveform signals can then be amplified S430 in preamplifiers and the amplified signals can be sent to a processor, for example, the amplified signals may be sent to a controller by way of BNC cables. The controller may be any suitable apparatus, including, for example a programmable logic controller (PLC). The controller determines whether the waveform exceeds a predetermined trigger threshold S440. For example, the controller determines whether the waveform exceeds the normal background noise emission levels such as to indicate that a damage event has occurred. If the waveform does not exceed the trigger threshold, the controller can be configured to ignore or choose not to further process the waveform S450. If the waveform exceeds the threshold, the controller digitizes the waveform for processing S460. The digitized waveform may be displayed on a monitor in real time as the AE data is collected by the sensors S470. The data may be automatically saved at predetermined time intervals, for example hourly, and used for post-analysis and correlation with operational events. AE signal processing may include autopicking arrival times for waveforms based on preset parameters to locate the AE events in 3D space S480. The controller can output a 3D image of the runner being tested showing the source location and relative amplitudes of the acoustic emissions occurring in the runner.

The controller is in communication with each of the sensors affixed to the runner. The location of each sensor is known by the controller. When a sensor detects an acoustic emission above a pre-determined threshold, the controller determines the source of the emission as either a sensor emitted signal or as attributable to an AE event in the runner. The pre-determined threshold may be for example a wave frequency above the frequency emitted by the flow of molten metal along the runner or a known frequency from a sensor emitted signal. The source of the acoustic emission and its location may be used by the controller to identify a deterioration as well as to determine the type of failure in the runner. Failures may include cracks and crack growth or propagations within the refractory lining and on the face of the working refractory layer. Failure of the runner may also include wear over time of the refractory at the molten metal-refractory interface.

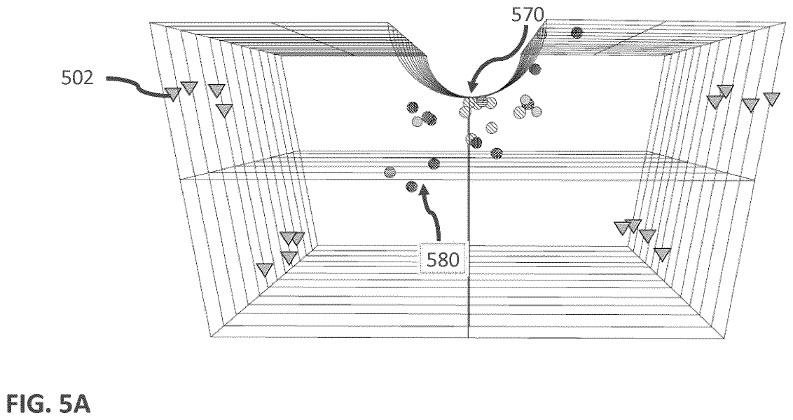

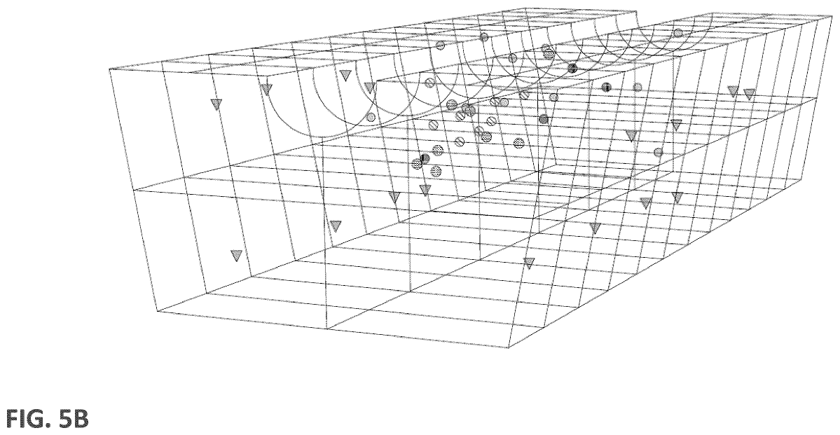

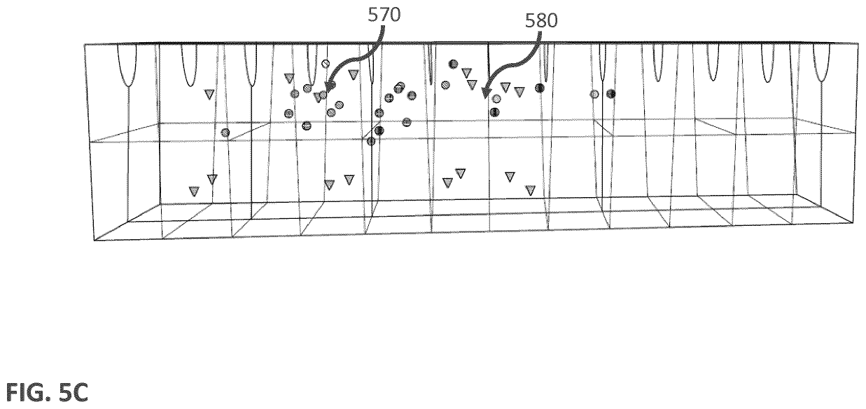

FIGS. 5A-5C show example 3D image outputs, in accordance with an embodiment of this invention, as may be depicted for example on a monitor from the 3D location analysis described in FIG. 4. The processed AE signal output shows the number of recorded acoustic events, their location and their magnitudes. For example, as shown in FIGS. 5A-5C, a 3D grid depicting the runner may be outputted to a monitor. The 3D image may be rotated to view the runner from various angles. In addition, the known location of each of the sensors 502 is identified in the output. When acoustic emission events occur in the runner, the events are recorded and displayed in real time on the 3D grid of the runner. Each event can be colour coded to identify the magnitude of the event. For example, the events shown with circles having diagonal hatching in FIGS. 5A-5C indicate higher energy events 570 while those with criss-cross hatching indicate lower energy events 580. If a particular location is determined to contain many high energy events, for example a cluster or large concentration, shown as higher density dots in FIGS. 5A-5C, it can be determined that that location of the runner is encountering continuous or progressing damage. In an example, the damage may be due to thermal or friction induced cracking, and can be further checked or monitored. Once a damage zone is identified, for example by the occurrence of a cluster of high energy events, a tomographic detection or slice of that zone can be made to further investigate the damage zone. The tomographic detection can be made by emitting acoustic signals from the sensors through the refractory lining, and detecting those signals with the sensors to produce a velocity survey that identifies, in a cross-sectional view, the precise location of the damage.

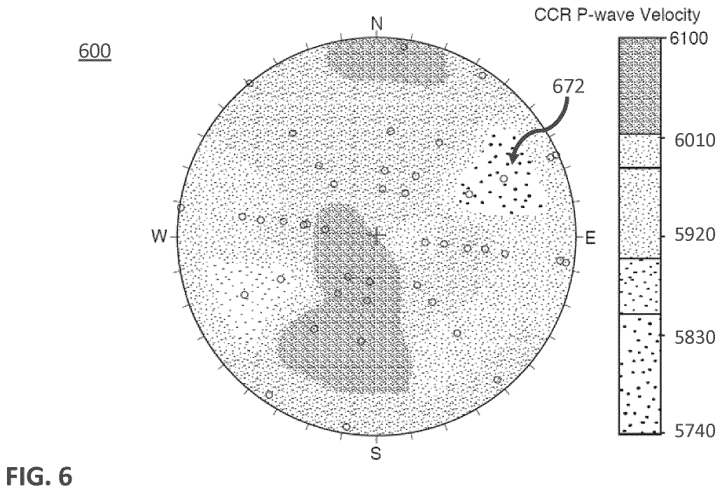

FIG. 6 shows a stereographic projection of p-wave velocities 600 through a portion of an example runner according to an embodiment of the invention with a damaged refractory lining. The velocity survey can be used to identify areas in the refractory where the velocity changes. Faster velocities indicate areas of the refractory with high quality brick, while slower velocities indicate cracking or breaking or otherwise loss of integrity of the refractory brick. In the example shown, the area with the slowest velocity 672 indicates that this portion of the refractory has sustained damage and will need to be investigated further and possibly replaced. An area having a cluster of high energy events 570 as shown in FIG. 5 may produce areas of damaged refractory that will show up as slower velocity areas 672 as shown in FIG. 6.

The AE monitoring system can be configured to monitor the acoustic emissions within a runner over a period of time. This monitoring of the acoustic emissions within the runner may be continuous, periodic, and/or in real time. The system may generate warning or alert outputs if changes in structural integrity are detected as a result of the monitoring. For example, the system can be configured to generate a warning or alert if more than a specific number of events with a predetermined wave amplitude are detected in a region of the runner or if even a single event is detected with an extremely high wave amplitude indicating a large cracking event occurrence. Acoustic emission can be used to infer the integrity of the refractory. In an embodiment, detection of higher energy events may for example be determined to correspond to events occurring at the refractory-molten metal interface. In an embodiment, it is assumed that no AE events will locate past the interface in the molten metal. A reasonable outline of the refractory integrity can be determined based on the foregoing.

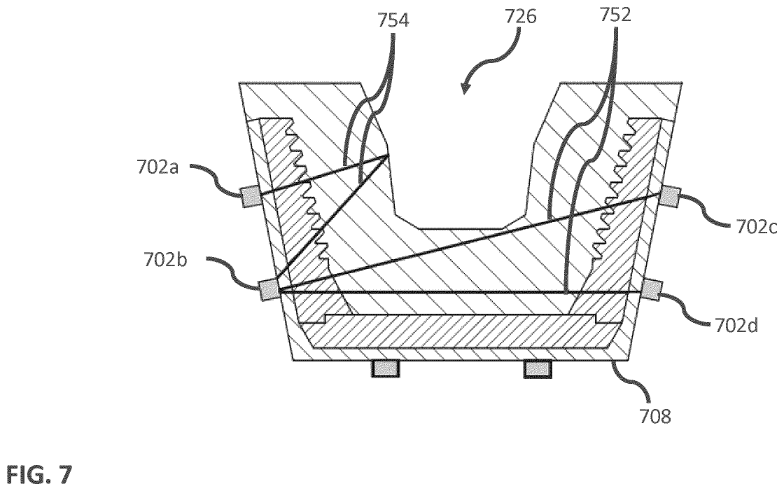

FIG. 7 shows a cross section of a runner with an acoustic emission system comprising sensors along its outer walls according to another embodiment of the invention. The system can be used to assess the thickness and integrity of the refractory lining in the runner over time. The system comprises AE sensors permanently or detachably fixed on the walls and/or bottom 708 of the runner. The sensors act as both source and receivers. Velocity surveys of the signals sent/received from/by the sensors may be taken manually or automatically at periodic time intervals. In an example with at least some of the AE sensors positioned on the sidewalls at a level below the bottom of the trough, a plurality of the AE sensors each pulse (emit) an AE signals sequentially into the runner lining while the other sensors passively wait for and detect the signal. These velocity survey signals can be used to determine the P-wave velocity below the trough. The changes in the P-wave velocity over time, for example over a number of regularly scheduled/timed surveys, can be used to determine changes in the refractory material property to assess lining integrity and any deterioration therein. In an example velocity survey, one sensor affixed to the runner at a height below the trough is used to emit an electric signal that produces an acoustic emission, while one or more sensors on the opposite side of the runner detect the signal after it has passed through the refractory. The time it takes for the signal to propagate through a known distance in the refractory is collected. The emission and detection sequence is repeated over a period of time and the collected wave propagation times are analyzed to identify a deterioration in the refractory. An increase in the time from emission to detection of the signal may indicate a deterioration in the refractory lining. In an example, the collected times and the distance between emitting and detecting sensors are used to compute a velocity survey. This process may be repeated over a period time to compare the detected velocities and determine any damage based on a decrease in velocity of the signal over time. The collected times may also be compared to a predetermined baseline indicative of refractory integrity. In an example, the process is repeated over a period of time for a specified section of the runner.

In FIG. 7, sensor 702b emits a wave signal 752 that is detected by both sensors 702c and 702d. Placing the sensors across from each other with no molten metal or dead space in the wave path between them allows the sensors to send and receive signals that can propagate through the entire distance of the refractory material between them. The collected signals can be used to complete velocity/tomography surveys. Tomography using AE sensors comprises monitoring the occurrence of events based on data from the sensors and producing tomographic images or cross sections of specific segments of the runner. Taking a plurality of tomographic images/velocity surveys over time of the same slice/cross-section of the runner allows for comparison of the refractory integrity over time. For example, higher velocities may indicate higher quality refractory brick while lower velocities may indicate lower quality or damaged refractory brick. The velocity survey may be used to monitor changes in the physical properties and quality of refractory brick over time, such changes include cracking, anomalies/voids and changes in chemical compositions. The results of the velocity surveys taken over time provide data for future use to determine refractory wear rates and may be used for identifying areas in or segments of the runner that are more damaged and susceptible to cracks and runouts.

In another example, sensors placed on the outer walls of the runner adjacent to the channel 726 can be used as a source and receivers to detect the refractory thickness in a segment of the runner from the outer wall to the refractory-metal interface, over time. Similar to the through transmission method, a sensor 702a can be used to emit an acoustic emission. Unlike the through transmission method, the acoustic emission does not travel through the entire runner to a sensor on the other side and instead reflects against the molten metal-refractory interface of the channel 726 back towards the source sensor 702a or other nearby sensors 702b. This method allows for refractory thickness measurements that can be repeated over time to assess the integrity of the runner. An increase in time between an earlier reading and a later reading may indicate a deterioration or wear in the runner segment over the time between readings. In this case, the sensors 702a, 702b receiving the reflected waveforms 754 detect the time domain of the signal as well as the frequency domain of the signals and can determine if the frequency corresponds to a reflection of the emitted signal. In this way, the system can assess if the location of the reflection changes over time based on the time domain collected and can determine a wear or wear-rate in the runner.

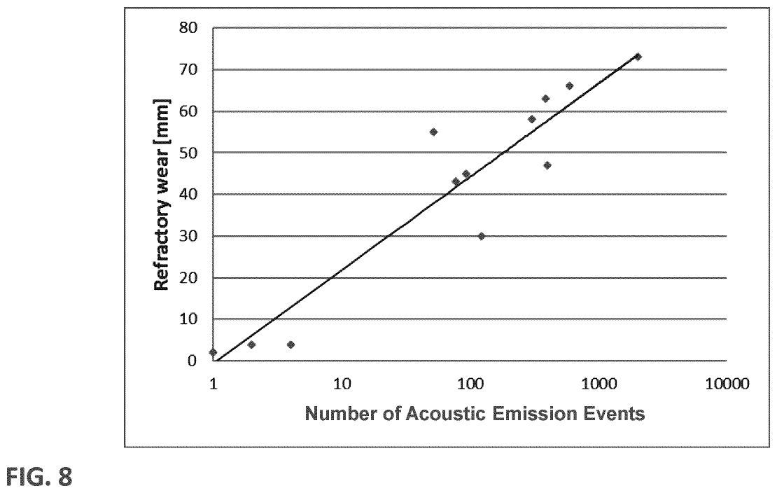

FIG. 8 shows a graph correlating the acoustic activities with the amount of wear and deterioration in the refractory lining according to an embodiment of the present invention. As seen in the graph and previously described, an increase in the sum of recorded AE events may indicate a deterioration of the refractory lining. The system according to an embodiment of the invention can therefore be used to assess the structural integrity of the refractory lining even if the exact location of an event is not identified. By accounting for the number of events occurring in a section of the refractory, and using a corresponding tomographic image of that portion of the refractory, the damaged zones can be identified as the areas showing slower velocities and increased numbers of events. Therefore, by correlating the AE activity with the amount of wear in the lining, a refractory wear rate can be calculated and extrapolated for a specific location to determine the optimal relining period.

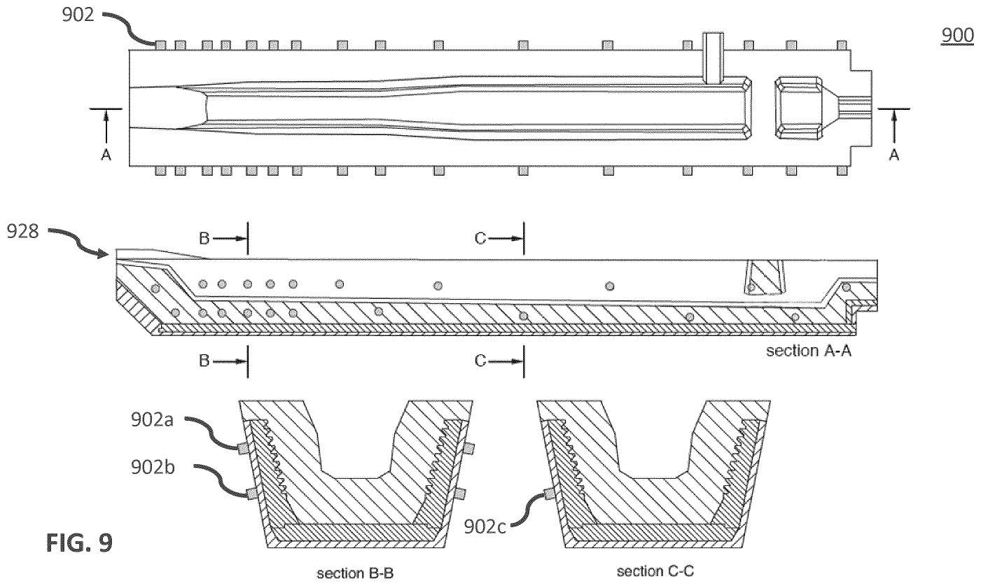

FIG. 9 shows a molten metal runner equipped with an acoustic emission runner integrity monitoring system 900 according to an embodiment of the invention. The runner is equipped with sensors 902 on each sidewall. The sensors are distributed along the length of the runner in higher and lower density clusters. In the portion of the runner closest to the tapholes 928 where the molten material is the hottest, an increased number of sensors are mounted in anticipation of more failure causing events occurring in this region of the runner. The increased number of sensors allows an increased accuracy of event location detection. A less dense array of sensors cover the remainder of the runner in amounts sufficient to cover any blind spots. The sensors may be evenly or unevenly spaced in the higher and lower density clusters and the system may be calibrated such as to filter out background noise from the flowing molten metal and other environmental noise sources. As can be seen in the section along line B-B of FIG. 9, two sensors are placed on each sidewall of the runner with a first sensor 902a in-line with the molten metal path and a second sensor 902b at a height below the molten metal path. In the example shown along line C-C, where a less dense cluster of sensors are positioned, there is only one sensor 902c positioned at a height below the molten metal path. In the case where only one sensor is used in a particular section, alternating whether the sensor is below or in-line with the path and whether the sensor is on one side wall or the other, may help reduce blind spots while continuing to use less sensors. All of the sensors act as both source and receiver. Some sensors are used to periodically emit electric signals as acoustic emission waves through the refractory. The waves may be either reflected off the inner channel walls and detected by the same or nearby sensors or transmitted through the whole refractory and detected by sensors on an opposite side wall. The collected sensor emitted signals can then be used to produce tomographic images or velocity surveys of the runner section to determine the integrity of the runner. Specifically, the wear rate of the refractory and/or it's thickness at specific locations over time can be determined using the velocity surveys. Other sensors are used to passively and continuously monitor the refractory for any indication of an acoustic emission event such as caused by the start of a crack. Any detected acoustic emission events are collected by the sensors and transmitted (after pre-amplification if required) to the control system. The control system and memory produce an output indicating the specific location (if four or more sensors detect the event) and magnitude of the acoustic events. The large amount of data collected by all of the sensors, even if unable to locate specific events, can also be used to determine the damage zones in the refractory lining where larger amplitude events are detected. In addition or in the alternative, the control system may produce a warning signal or alert if a specific event or events are recorded that exceeds a predefined threshold.

The system and method of acoustic emission runner integrity monitoring according to the invention may help with continuous and/or real-time monitoring of wear in the runner refractory, more accurate determinations of the condition of the refractory, means for estimating the remaining refractory in zones using AE energy, providing warning/alarms for failures in refractory, determining the refractory deterioration trend, and reducing the amount of down time and refractory reline and repair of the lining.

1. A method for assessing the structural integrity of a furnace runner, the method comprising,
affixing sensors on outer walls of the runner;
performing a sequence comprising,
emitting an acoustic emission (AE) signal from a first sensor into a runner segment;
detecting the AE signal at the first sensor or at a second sensor separated from the first sensor by the runner segment; and,
recording a time from signal emission to signal detection;
repeating the sequence over a period of time; and,
identifying a deterioration in the runner segment based on a change in the recorded times over the period of time.

2. The method of claim 1 wherein an increase in the recorded times over the period of time identifies a deterioration in the portion of the runner.

3. The method of claim 1 or 2 further comprising determining the velocity of each signal over the period of time based on a distance between the emitting and detecting sensors and the recorded time.

4. The method of claim 3 wherein a decrease in the velocity over time identifies a deterioration in the portion of the runner where the emitting sensor is not the same as the detecting sensor.

5. The method of claim 1 comprising receiving the AE signal at the first sensor after reflection off a molten metal-refractory interface inside the runner.

6. The method of claim 1 wherein the AE signal propagates between the first sensor on a first outer wall and the second sensor on an opposite second outer wall of the runner to identify the deterioration below a channel of the runner.

7. The method of claim 1 further comprising affixing the sensors on or embedded in a metal shell encasing the outer walls of the runner.

8. The method of claim 1 further comprising affixing a higher density of the sensors around expected damage areas of the runner.

9. The method of claim 8 wherein the expected damage areas are determined by any one of historical data, proximity to the furnace and preliminary testing of the runner.

10. The method of claim 1, further comprising detecting a second AE signal originating in the runner from a failure event, and determining a location and magnitude of the failure.

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. A method for assessing the structural integrity of a furnace runner, the runner comprising a trough for flowing molten metal, a first sidewall, and a second sidewall opposite to the first sidewall, the method comprising,
affixing a plurality of sensors on the first and second sidewalls of the runner, the plurality of sensors arranged with
at least a first of the sensors affixed at a first height on one of the sidewalls to detect an acoustic emissions (AE) signal passing through the runner below the trough, and
a second of the sensors affixed at a second height on the other sidewall to emit or detect the AE signal passing through the runner below the trough that reaches the first sensor;
sensing AE signals in the runner over a period of time using the sensors;
filtering the signals based on a pre-determined frequency range;
determining the structural integrity in a portion of the runner below the trough based on AE signals associated with the first and second sensors.

25. The method of claim 24 wherein at least one of the first height and the second height is below the trough.

26. The method of claim 24 wherein the first height and the second height are the same.

27. The method of claim 24 wherein determining the structural integrity in a portion of the runner comprises identifying a damage zone or locations of AE events in the runner based on the AE signals associated with the first and second sensor over the period of time.

28. The method of claim 24 wherein the first and second sensors detect AE signals produced by AE events occurring within the runner.

29. The method of claim 24 wherein the second sensor periodically emits the AE signal passing below the trough and the first sensor detects the emitted AE signal.

30. A system for monitoring acoustic emission events, the system comprising,
a molten metal runner, the molten metal runner comprising a first sidewall and a second sidewall opposite to the first sidewall, and a trough for flowing molten metal;
at least four acoustic emission (AE) sensors mounted to sidewalls of the runner, wherein
a first of the sensors is mounted one of the sidewalls at a first height to detect an AE signal passing through the runner below the trough, and
a second of the sensors is mounted to the other of the sidewalls at a second height to emit or detect the AE signal passing through the runner below the trough that reaches the first sensor; and,
a controller configured to determine the structural integrity in a portion of the refractory lining below the trough based on the AE signal associated with the first and second sensors.

31. The system of claim 30 wherein at least one of the first height and the second height is below the trough.

32. The system of claim 30 wherein the first height and the second height are the same.

33. The system of claim 30 wherein the controller is configured to identify a damage zone or locate AE events in the runner based on the AE signals associated with the first and second sensor.

34. The system of claim 30 wherein the first and second sensors are configured to detect AE signals produced by AE events occurring within the refractory lining.

35. The system of claim 30 wherein the second sensor is configured to periodically emit an AE signal and the first sensor is configured to detect the emitted AE signal.
